(19) United States
(12) Patent Application Publication
(10) Pub. No.: US 2026/0214299 A1
(43) Pub. Date: Jul. 23, 2026

(54) Content Insertion based on Group Attention

(71) Applicant: Comcast Cable Communications, LLC, Philadelphia, PA (US)

(72) Inventor: Ganesh Narayanan, Chennai (IN)

(21) Appl. No.: 19/034,958

(22) Filed: Jan. 23, 2025

(51) Int. Cl. H04N 21/442; G06F 3/01; G06V 40/16

(52) U.S. Cl. CPC H04N 21/44218; G06F 3/013; G06V 40/174

(57) ABSTRACT

Systems, apparatuses, and methods are described for dynamic content insertion. Content insertion may be based on monitoring feedback, from one or more sensors, of a plurality of users looking in the direction of a device that is outputting content. A threshold quantity of the plurality of users looking in the direction of the outputted content may be determined. Secondary content may be inserted during presentation of the content currently being viewed, for example, based on the threshold quantity and sensor feedback of the plurality of users.

### BACKGROUND

The ability to dynamically insert content into other content, such as inserting a second video into a first streaming video, may allow for greater flexibility in content delivery services.

### SUMMARY

The following summary presents a simplified summary of certain features. The summary is not an extensive overview and is not intended to identify key or critical elements.

Systems, apparatuses, and methods are described for managing insertion of a secondary content item, such as a secondary video or advertisement, into the presentation of a primary content item, such as a streaming movie or television program The insertion of the secondary content item may be based on monitoring, using one or more sensors, reactions and attentiveness of an audience viewing the primary content item, such as by monitoring audience member's eye gaze (e.g., area of visual focus) or other sensor feedback information. The secondary content item may, for example, include, but not limited to, emergency announcements, system outages, scheduled events, video, and ads. Content items being inserted during a peak time of attentiveness may, for example, help ensure that important content items are provided to an audience while the audience is paying attention.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIGS. 3a-b show an exemplary monitoring environment.

FIG. 4 shows an example attention timeline of an audience.

FIG. 5 shows exemplary modules for content insertion.

FIG. 6 shows an example method for content insertion.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

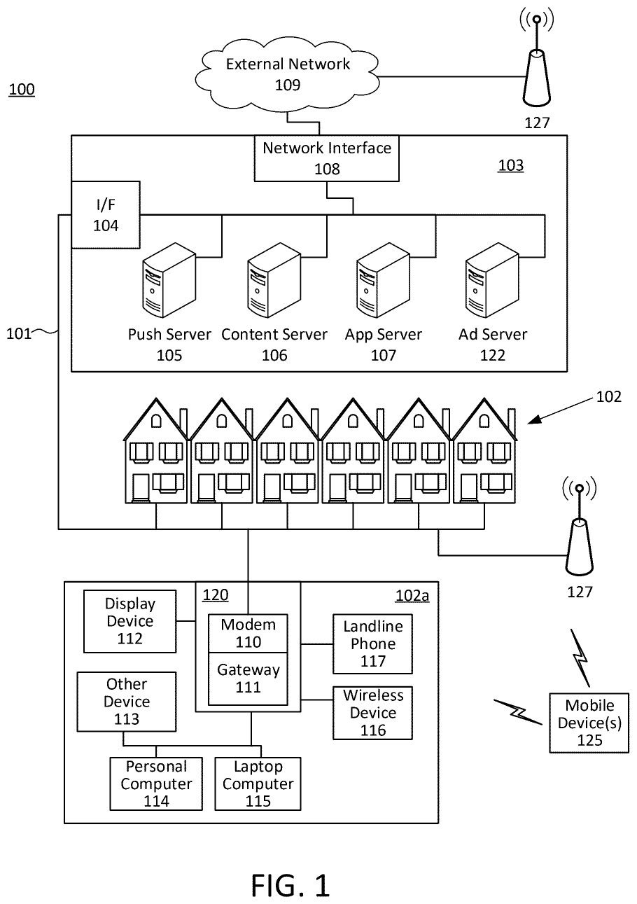

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as the advertisement server 122 (described below), additional push, content, and/or application servers, and/or other types of servers. The advertisement server 122 may be configured to retrieve advertisements to be displayed on devices in the premises 102 and/or on the mobile devices 125. The advertisement server 122 may, for example, determine which ads may be selected to be presented during a specified time. Although shown separately, the push server 105, the content server 106, the application server 107, the advertisement server 122, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g., Voice over Internet Protocol—VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on-or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

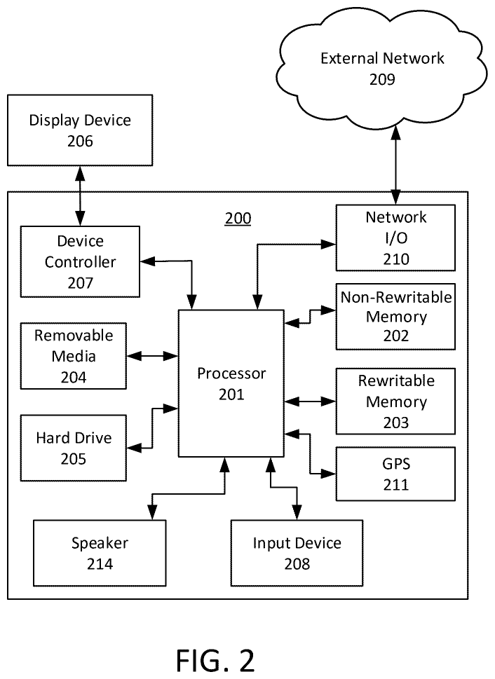

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., computing device 500). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

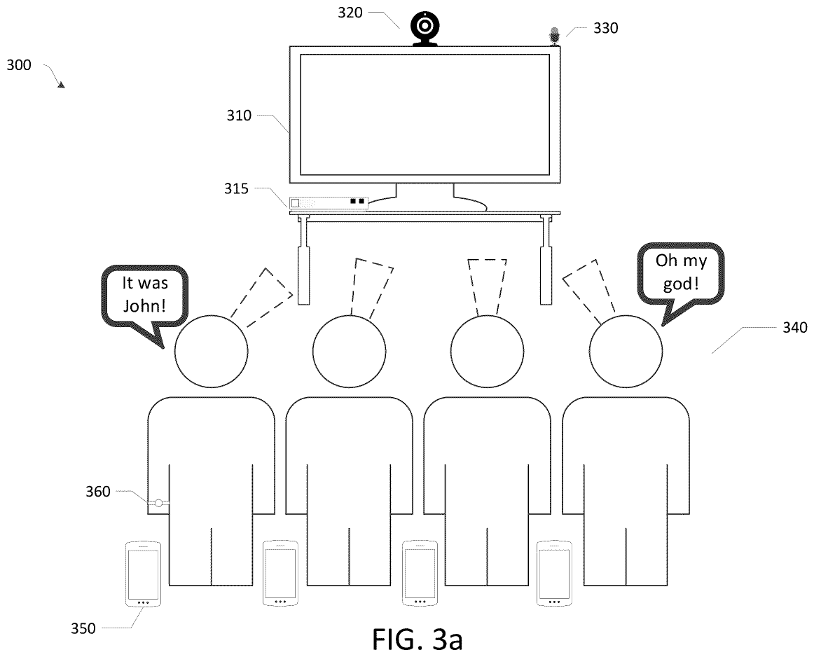

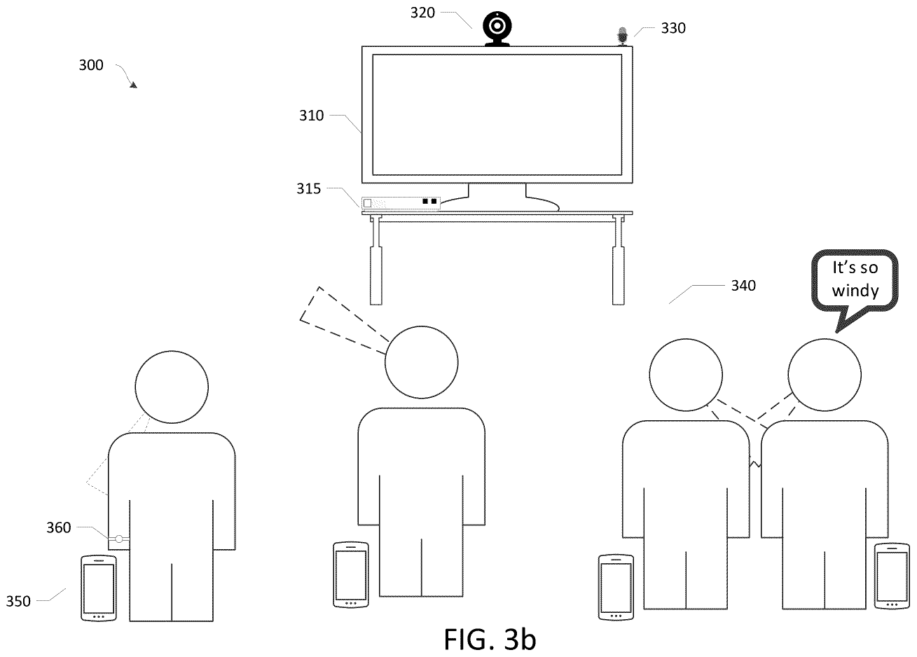

FIG. 3a-b show an exemplary monitoring environment. The monitoring environment 300 may comprise an audience 340. The audience 340 may comprise a plurality of users viewing content on one or more video output device 310. The monitoring environment 300 may, for example, be within a house (e.g., premises 102 of FIG. 2). The monitoring environment 300 may monitor the audience 340 for feedback. The feedback may include, for example, sensor feedback of the audience 340 from one or more sensors. Content insertion may be based on the feedback. The feedback may, for example, include gestures, reactions, movements, conversations, proximity, positioning, distractions, cell phone usage, demographics, behavior, temperature details, heart rate, and user metadata. A user having eye gaze towards a first content item being presented may be indicative of good attention. The user having eye gaze away from the first content item being presented may be indicative of poor attention. The direction of a user's eye gaze may indicate different levels of attentiveness. The user having an excited facial expression (e.g., wide eyes, raised eyebrows, and open mouth) may be indicative of good attention. The user having a blank facial expression (e.g., having facial features at a default position) may be indicative of poor attention. A user screaming/cheering may be indicative of good attention. The user being silent may be indicative of poor attention. A user's body position facing the first content item may be indicative of good attention. A distracted user's body position (e.g., sleeping, looking at phone, facing towards another user) may be indicative of poor attention. The user having an elevated heart rate may be indicative of good attention.

The monitoring environment 300 may comprise a video output device 310. The video output device 310 may, for example, be a television, display, computer monitor, or projector. The video output device 310 may display content for viewing. The video output device 310 may, for example, be a display or television. The monitoring environment 300 may further comprise a video receiver 315. The video receiver 315 may, for example, be a DVR or STB. Video receiver 315 may be connected to the video output device 310. Video receiver 315 may retrieve information from one or more servers (e.g., content server 106, ad server 122). Video receiver 315 may retrieve a first content item, such as a television show or movie. The first content item may, for example, be a received broadcast or a streaming video. The first content item may be displayed on the video output device 310, for example, if retrieved by the video receiver 315. The video receiver 315 may also retrieve a second content item. The second content item may include emergency announcements, system outage notification, scheduled events, video, and ads. The second content item may be insertion during presentation of the first content item. Feedback of the audience 340 may be monitored during presentation of the first content item. The second content item may be inserted at a time that is based on the feedback of the audience 340 during presentation of the first content item. The video receiver 315 may additionally retrieve a third content item and the third content item may be insertion during presentation of the first content item. A SCTE 35 message may indicate to the video receiver 315 to output a second content item. The video receiver 315 may decide not to output (or wait to output) the second content item, for example, based on an attention level of the plurality of users viewing the first content item. Alternatively, the video receiver 315 may wait to output the second content item until the attention level of the plurality of users is met. The attention level may, for example, be based on a threshold level of the plurality of users looking in the direction of the outputted first content item.

The monitoring environment 300 may comprise camera 320. Camera 320 may record and/or monitor the audience 340. Camera 320 may have thermal capabilities. Camera 320 may generate thermal images. The thermal images may be used to determine how many audience members are present. Camera 320 may comprise a processor with facial recognition features. The processor may process the camera's images. The processor may reside within the camera 320 or be external to the camera 320 and may be a separate device from the camera 320. Camera 320 may, for example, recognize a plurality of users in the audience 340 based on the facial recognition. Camera 320 may, for example, monitor facial expressions of the plurality of users in the audience 340. Camera 320 may determine proximity of the plurality of users based on distances detected. Camera 320 may determine the facial orientation of the plurality of users. Users facing the video output device 310 may, for example, be determined to be more attentive. Users facing away from the video output device 310 may, for example, be determined to be less attentive. Individual actions of users may be combined to generate a degree of attentiveness. For example, a user having a blank facial expression, a closed mouth, and looking at a phone may indicate low attentiveness. A user having eye gaze towards the first content item, raised eyebrows, fully opened eyes, and body positioned leaning towards the first content item may indicate high attentiveness. The camera 320, using the processor, may collect various actions of the plurality of users and indicate attentiveness based on a combination of the collected actions. Indicating attentiveness based on a combination of action may yield more accurate attention levels. Camera 320 may further comprise a microphone for monitoring audio. The microphone may be part of the camera or an individual component (as discussed herein).

The monitoring environment 300 may further comprise microphone 330. Microphone 330 may record/monitor audio of the audience 340. Microphone 330 may comprise a processor with speech recognition capabilities. Microphone 330, using the processor, may determine user engagement based on speech recognition. A user may say “oh my god!” or gasp in excitement and may indicate high attention. The user may be talking with another user about an unrelated topic (e.g., weather) to the content being presented (e.g., cartoon) and may indicate low attention. Additionally, keywords from the plurality of users may be recognized. A transcript of the content item being viewed may be obtained by the processor, for example, from the video receiver 315. The keywords may be compared to the transcript of the content being viewed. As an example, a transcript of a movie may be obtained. Microphone 330, using the processor, may recognize audio from the plurality of users, such as character names or character actions in the movie. The audio may be compared with the transcript. The transcript may be processed by the processor to generate a list of words (e.g., words corresponding to a scene). The list of words may, for example, contain “knight”, “dragon”, “sword”, “victory”, and “battle” corresponding to a fighting scene shown in the content item. Each word in the list of words may be associated with a corresponding value indicating different degrees of attentiveness (e.g., on a scale from 1-10, 1 may indicate low attentiveness and 10 may indicate high attentiveness). A user may say “I can't believe the knight killed the dragon with the sword”. Words such as “knight”, “dragon”, and “sword” may align with the transcript for a fighting scene being presented and may indicate high attention (e.g., rated a 9 on a scale from 1-10). The user may say “it is sunny outside”. The processor may identify no matching words with the transcript and may indicate low attention (e.g., a distraction from the scene). The audio of the audience 340 may be combined with images of the camera 320 to indicate an attention level. For example, a user watching a football game may be monitored. The user screaming in excitement, jumping up and down, and yelling “touchdown” may indicate high attentiveness.

The monitoring environment 300 may comprise mobile devices 350. Mobile devices 350 may, for example, be any personal device such as a tablet, smart phone, or smart watch. Mobile devices 350 may comprise cameras with thermal sensors and/or infrared (IR) sensors. Mobile devices 350 may be used to monitor social media traffic. The mobile devices 350 may further comprise a camera for monitoring the plurality of users of the audience 340. A user posting on social media about the content being viewed may indicate good attention.

The monitoring environment 300 may further comprise heart monitor 360. The heart monitor 360 may, for example, be a watch. The heart monitor 360 may detect heart rate of users. An elevated heart rate may indicate an elevated level of attentiveness. A sedated heart rate may indicate the user is bored or asleep and paying less attention. The monitoring environment 300 may, for example, use the facial recognition, speech recognition, and heart rate level to determine attentiveness. Attentiveness may be based on a combination of inputs. For example, a user having high heart rate and having eye gaze towards the content item being presented may indicate high attentiveness. The same user having high heart rate but having eye gaze away from the content item being presented may indicate lower attentiveness. Additionally, a user facing away from the content item being presented but saying something related to the content item being viewed (e.g., “Oh my god! The burglar was John!”) may indicate high attention even if the user was facing away from the content item. A user with a sedated heart rate and having a body position of laying down may indicate low attention. A user with an elevated heart rate and having a body position of leaning forward (e.g., leaning forward while seated on a chair) may indicate high attention.

FIG. 3a shows an audience 340 watching content displayed on a video output device 310. The plurality of users in the audience 340 may be gathered together and be positioned directed in front of the video output device 310. The audience 340 may have eye gaze towards the content item displayed on the video output device 310. The speech recognition of microphone 330 may have recognized conversations (e.g., discussing a scene) related to content item displayed (e.g., TV show). For example, a user may yell in excitement “oh my god!” and “it was John!” in relation to a scene revealing John as a burglar. The speech recognition may recognize the keywords and compare with a transcript of the TV show. The mobile devices 350 may all be switched off and may not pose as a distraction. The heart rate monitor 360 may indicate elevated heart rates and may indicate excitement. The audience 340 may be categorized as having high attention based on the cumulative feedback of the audience 340, as shown in FIG. 3a. FIG. 3b shows the audience 340 distracted from content displayed on the video output device 310. The plurality of users in the audience 340 may be dispersed in a room and be positioned away from the video output device 310. The audience 340 may have eye gaze away from the content item displayed on the video output device 310. The speech recognition of microphone 330 may have recognized conversations (e.g., conversation related to weather) non-related to content item displayed (e.g., TV show). A user may say “it's so windy” in relation to the weather outside, for example, while the content item is not currently related to the weather (e.g., based on a content item transcript not containing any current words relating to weather, or a current image not containing any images of clouds or the sky, or metadata describing a current scene as being related to topics that do not include the weather). A user may be distracted while using mobile devices 350. The heart rate monitor 360 may indicate sedated heart rate levels and may indicate tiredness. The audience 340 may be categorized as having low attention based on the cumulative feedback of the audience 340, as shown in FIG. 3b.

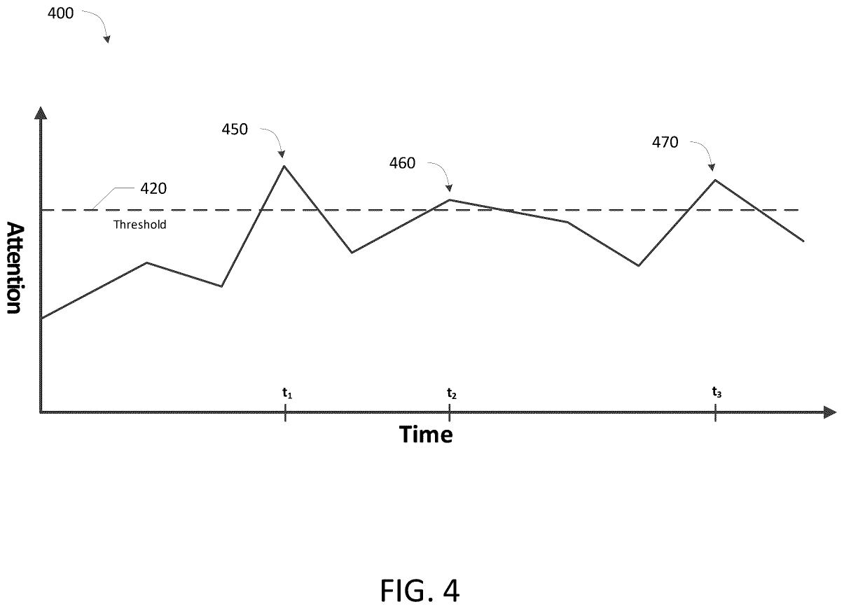

FIG. 4 shows an example attention timeline of an audience. Timeline 400 shows attention of an audience over time. Each factor of attentiveness (e.g., direction of face, spoken words, phone data usage, etc.) may have its own scale of attentiveness. The facial detection, using camera 320, may generate a score (e.g., 1-10) associated with attention. A user with eye gaze towards a content item and positioned closer to the content item may indicate a higher score (e.g. 9/10). The score associated with facial detection may indicate a score based on the distance from the user to the content item displayed. A closer position may indicate a higher score (e.g., 9/10), while a further position may indicate a lower score (e.g., 3/10). The speech recognition, using microphone 330, may generate a score associated with attention. The speech recognition may compare recognized spoken words of the user with a transcript of the content item displayed. A score may be indicated based on comparing keywords of the spoken words with the transcript. A higher score (e.g., 9/10) may be indicated by a high matching of keywords to the transcript. A lower score (e.g., 2/10) may be indicated by no matching of keywords to the transcript. The feedback from the facial detection and speech recognition may be combined with heart rate of the users to indicate an overall attention score. The scores indicated by the facial detection, speech recognition, and heart rate may be added and weighted to generate the overall attention score. Alternatively, the scores may be averaged to generate the overall attention score (e.g., 1-10). The y-axis of timeline 400 may display the overall attention scores. Threshold 420 may indicate the level at which the audience's attention score is high. The threshold 420 may be user defined or selected based on historical viewing data of the content being viewed by the audience. The threshold may be based on the second content item to indicate how much attention is needed for a certain secondary content item to appear. For example, the threshold may be set to a low value (e.g., 1) if the second content item is an emergency weather announcement. The emergency weather announcement may be output even if the audience is not paying attention, because the announcement is of utmost importance. The threshold may be set to a high value (e.g., 8) if the second content item is an ad. Each type of feedback may have a relative importance value associated with the second content item. A first type of feedback may be weighted more than a second type of feedback. The second content item (e.g., questionnaire) may place a higher importance value for proximity of the plurality of users to the content item presented and a low importance value for speech of the plurality of users. Additionally, a second content item (e.g., ad) may place a higher importance value for both proximity and speech. The threshold may be adjusted based on the type of the second content item and may vary during the course of the content item (e.g., perhaps some parts of the content item are more resistant to being interrupted). For example, the threshold may be lowered if an unexpected emergency notification is to be presented.

FIG. 4 shows at least three instances at which the attention of the audience is above the threshold 420. At t1, a first peak 450 is shown having high audience attention. The first peak 450 may be selected as the time at which a new content may be presented during presentation of the content being viewed by the audience. The new content may, for example, be advertisements, logos, menus, notifications, questionnaires, and/or video content. At t2, a second peak 460 is shown having high attention. The second peak 460 may be selected as the second time at which a second new content may be presented during presentation of the content being viewed by the audience. At t3, a third peak 470 is shown having high attention. The third peak 470 may be selected as the third time at which a third new content may be presented during presentation of the content being viewed by the audience. The new content to be presented at the selected time may be based on the previous content presented and feedback of the audience.

Each peak may, for example, be identified based on facial recognition, speech recognition, and heart rate level of the plurality of users. First peak 450 may, for example, be identified based on the plurality of users all viewing the content being played (as shown in FIG. 3a). The plurality of users may, for example, be screaming in excitement, have excitement in their face, and elevated heart rates at t1.

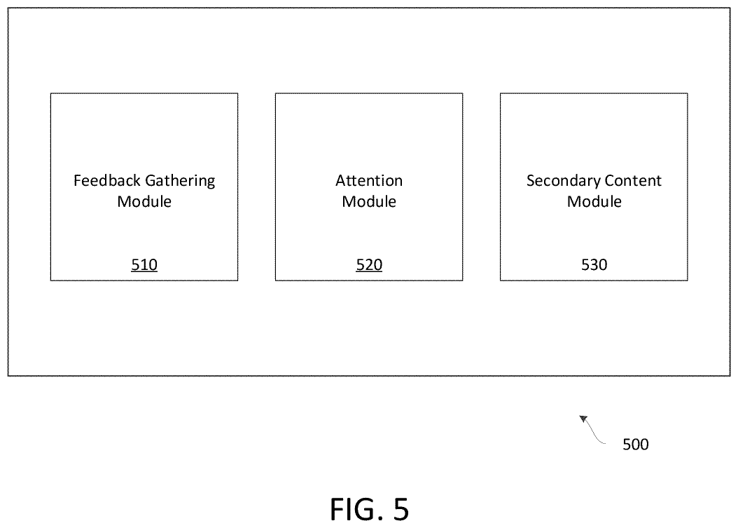

FIG. 5 shows an exemplary computing system comprising modules for content insertion. The computing system 500 may be, for example, a personal computer. The computing system 500 may include feedback gathering module 510, attention module 520, and second content module 530. Modules may be hardware and/or software that may be configured to perform as described, and may be computer-readable instructions that, when executed, cause a computing device (e.g., computing device 200) or processor (e.g., processor 201) to perform the various features described herein.

Feedback Gathering module 510 may obtain data associated with an audience (e.g., audience 340). The data may be feedback, from one or more sensors, of a plurality of users in the audience. The data may include, for example, thermal images, facial images, speech audio, heart rate levels, and user profiles. Data may be monitored/recorded based on a camera (e.g., camera 320), microphone (e.g., 330), and heart monitor (e.g., heart monitor 360).

Attention module 520 may process all inputs and data associated with the audience. The attention module 520 may indicate an overall attention level based on the processed inputs and data. Each factor of attentiveness (e.g., direction of face, spoken words, phone data usage, etc.) may have its own scale of attentiveness. The attention module 520 may generate an attention score (e.g., 1-10) associated with facial detection features (e.g., facial expression, proximity of user to viewing device, eye gaze, body position). A user with eye gaze towards a content item and having body position positioned closer to the content item may indicate a higher score (e.g. 9/10). The score associated with facial detection may indicate a score based on the distance from the user to the content item displayed. A closer position may indicate a higher score (e.g., 9/10), while a further position may indicate a lower score (e.g., 3/10). The attention module 520 may generate an attention score (e.g., 1-10) associated with speech recognition features (e.g., conversation of users and keywords associated to a transcript). The attention module 520 may compare recognized spoken words of the user with the transcript of the content item displayed. A score may be indicated based on comparing keywords of the spoken words with the transcript. A higher score (e.g., 9/10) may be indicated by a high matching of keywords to the transcript. A lower score (e.g., 2/10) may be indicated by no matching of keywords to the transcript. The attention module 520 may combine feedback from the facial detection and speech recognition with heart rate of the users to indicate an overall attention score. The attention module 520 may add the scores indicated by the facial detection, speech recognition, and heart rate to generate the overall attention score. The attention module 520 may average the scores to generate the overall attention score (e.g., 1-10).

Secondary content module 530 may determine if one or more secondary content items are to be inserted. The secondary content module 530 may determine a minimum time that must pass before one or more secondary content items may be inserted. The minimum time may be based on the type and/or duration of the one or more secondary content item. The secondary content module 530 may be coupled to the attention module 520. The secondary content module 530 may comprise a machine learning model. The feedback of the plurality of users may, for example, be inputted into the machine learning model. The machine learning model may, for example, predict future trends of the plurality of users. The future trends may, for example, be based on historic data relating to the content being viewed and the feedback of the plurality of audience. The secondary content module 530 may determine if one or more secondary content items are to be inserted, for example, based on the feedback of the audience being above a threshold. The threshold may be user identified. The threshold may be based on historical data relating to the content being viewed. The threshold may be based on the one or more second content item. The threshold may be based on the type of the one or more secondary content item available. The secondary content module 530 may set the threshold to a low value (e.g., 1) if the second content item is an emergency weather announcement. The secondary content module 530 may set the threshold to a high value (e.g., 8) if the second content item is an ad. Each type of feedback may have a relative importance value associated with the second content item. A first type of feedback may be weighted more than a second type of feedback. The secondary content module 530 may place a higher importance value for proximity of the plurality of users to the content item presented and a low importance value for speech of the plurality of users, for example, if the second content item is a questionnaire. The secondary content module 530 may place a higher importance value for both proximity and speech, for example, if the second content item is an ad. The secondary content module 530 may adjust the threshold based on the type of the second content item. For example, the threshold may be lowered if an unexpected emergency notification is to be presented. Secondary content module 530 may select one or more second content items to be inserted at the one or more timeslots. The second content items may, for example, be selected based on feedback, categorization of content being viewed, and user metadata.

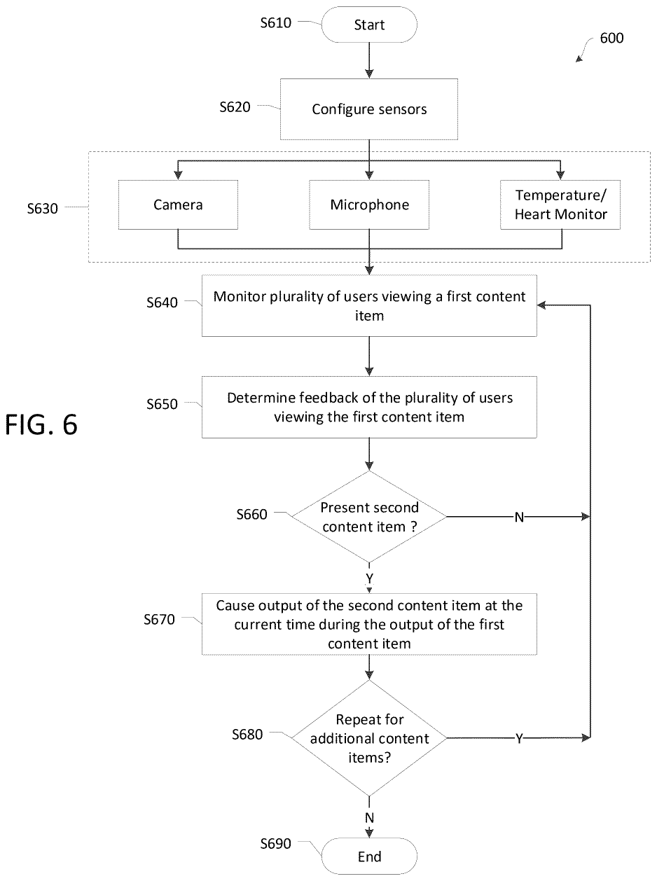

FIG. 6 shows an example method for content insertion. The method 600 may be implemented, for example, in a monitoring environment (e.g., monitoring environment 300) as shown in FIGS. 3a-b. The modules in FIG. 5 may be utilized in method 600. Method 600 begins in S610.

In S620, sensors may be configured. The sensors may be configured to collect and/or record data corresponding to a plurality of users. The sensors may be configured to generate scores associated with the data collected and attention levels. Camera 320 may be configured to indicate scores, for example, based on eye gaze. A user having eye gaze towards the video output device 310 may indicate a higher score compares to a user having eye gaze away from the video output device. The camera, using a processor, may be configured to generate a score 1-10 associated with attention. The processor may use the attention module 520, as described above in FIG. 5, to generate the score. The microphone 330, using the processor, may be configured to generate scores associated with speech collected from audience 340. Microphone 330, using the processor, may be configured to indicate scores, for example, based on comparison of speech of audience to a transcript of a content item being viewed. The attention module 520 may be configured with data indicating that if detected speech by the audience matches more than 30% of the words in a current segment of a content item's transcript, then that indicates a high degree of attention. Conversely, the data may indicate that if detected speech by the audience matches less than 5% of the words in the current segment of the content item's transcript, then this indicates a low degree of attention. A higher score (e.g., 9 on a scale from 1-10) may be associated with higher keyword hits (e.g., more than 30% matching of speech data and transcript) compared to a lower score (e.g., 1 on a scale from 1-10) for no keyword hits in the comparison. A score may additionally be configured for heart rate level. In this configuration, the Attention Module 520 may be provided with a heart rate data table indicating, for example, that a heart rate above 90 beats per minute may be associated with higher attention scores (e.g., 8 on a scale from 1-10), while heartrates below 70 beats per minute may be associated with lower attention scores (e.g., 2 on a scale from 1-10). The scores may be averaged and/or combined and weighted to determine an overall attention score. Weights may be assigned to the sensors based on the content being viewed or secondary content item to be inserted. A threshold value for content insertion may be assigned based on the content being viewed or the type of secondary content item to be inserted. For example, the threshold may be set to a low value (e.g., 1) if the second content item is an emergency weather announcement. The threshold may be set to a high value (e.g., 8) if the second content item is an ad.

In S630, a camera (e.g., camera 320), microphone (e.g., microphone 330), and heart monitor (e.g., heart monitor 360) may be initialized. The camera 320 may record a plurality of users in the audience. The camera 320 may comprise facial recognition and gesture recognition capabilities. The camera 320 may further comprise thermal capabilities for generating thermal images. Temperature details of the plurality of users may be determined based on thermal images. The microphone 330 may record audio of the plurality of users. The microphone 330 may further comprise speech recognition. The heart monitor may monitor heart rate of the plurality of users. The sensors may be used to monitor, for example, eye gaze, facial expression, body position, speech, loudness, and heart rate levels.

In S640, the sensors (e.g., camera, microphone, and heart monitor) may monitor the plurality of users looking in a direction of a computing device (e.g., video output device 310) that is outputting a first content item. The first content item may, for example, be a movie being viewed by the plurality of users on a video output device (e.g., video output device 310). Keywords from the plurality of users may be recognized. A transcript of the content item being viewed may be obtained by the processor, for example, from the video receiver 315. The keywords may be compared to the transcript of the content being viewed. As an example, a transcript of a movie may be obtained. Microphone 330, using the processor, may recognize audio from the plurality of users, such as character names or character actions in the movie. The audio may be compared with the transcript. A user saying knight, dragon, and sword may align with the transcript for a fighting scene being presented and may indicate high attention.

In S650, feedback of the plurality of users looking in the direction of the computing device (e.g., video output device 310) that is outputting the first content may be determined. Feedback Gathering module 510 may be used to generate the feedback. The feedback may correspond to traits of the plurality of users. The feedback may be used to, for example, determine the attention level of the plurality of users. A user having eye gaze towards a first content item being presented may be indicative of good attention. The user having eye gaze away from the first content item being presented may be indicative of poor attention. The user having an excited facial expression (e.g., wide eyes, raised eyebrows, and open mouth) may be indicative of good attention. The user having a blank facial expression (e.g., having facial features at a default position) may be indicative of poor attention. A user screaming/cheering may be indicative of good attention. The user being silent may be indicative of poor attention. A user's body position facing the first content item may be indicative of good attention. A distracted user's body position (e.g., sleeping, looking at phone, facing towards another user) may be indicative of poor attention. The user having an elevated heart rate may be indicative of good attention. A user may say “oh my god!” or gasp in excitement, which may indicate high attention. The user may be talking with another user about an unrelated topic (e.g., weather) to the content being presented (e.g., cartoon) and may indicate low attention. The audio of the audience 340 may be combined with images of the camera 320 to indicate an attention level. For example, a user watching a football game may be monitored. The user screaming in excitement, jumping up and down, and yelling touchdown may indicate high attentiveness.

In S660, a determination may be made to present a second content item at a current time during presentation of the first content item, based on the feedback. Attention module 520 may be used to determine attention levels of the audience. The determination to present may be based on the feedback being higher than a threshold (e.g., threshold 420). The overall attention score being higher than the threshold may, for example, correspond to determining to insert the second content item. The second content item may have an assigned duration, for example, based on the type of content. An emergency announcement may have a duration value of 60 seconds. A questionnaire may have a duration value of 45 seconds. The plurality of users may continue viewing the first content item at the end of the duration value for the second content item. The first content item may be assigned a maximum content insertion count. For example, a TV show episode may be assigned a maximum content insertion of 3 to allow for less disruption for a user viewing the content item. A determination may be made that a threshold quantity of the plurality of users are looking in a direction of the computing device that is outputting the first content item.

In S670, it may be determined to output the second content item at the current time during the output of the first content item. Secondary content module 530 may be used to determine the second content item to be inserted in S670. The plurality of users may be monitored during presentation of the second content item and the feedback may be updated. The plurality of users may continue viewing the first content item at the end of the duration value for the second content item. The outputting of the second content item may, for example, be based on the feedback of the plurality of users. The outputting of the second content item may, for example be based on the threshold quantity of the plurality of users looking in the direction of the outputted first content item.

In step 680, the first content item may be resumed. S640-S670 may be repeated to continuously monitor the audience 340. A third content item may, for example, be presented/inserted at a second time during presentation of the first content item. The third content item may be based on feedback of the plurality of users who viewed the second content item. The third content item may be modified based on the feedback. Method 600 ends at S690. Method 600 may end, for example, if the first content item has been completed.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
determining feedback of a plurality of users who are looking in a direction of a computing device that is outputting a first content item;
determining that a threshold quantity of the plurality of users are looking in the direction of the computing device; and
based on the threshold quantity, causing output of a second content item at a time that is based on the feedback of the plurality of users during the outputting of the first content item.

2. The method of claim 1, wherein the time of the output of the second content item is based on eye gaze of each of the plurality of users.

3. The method of claim 1, wherein the time of the output of the second content item is based on eye gaze and audio captured proximate to the plurality of users.

4. The method of claim 1, wherein the time of the output of the second content item is based on a facial expression of one of the plurality of users.

5. The method of claim 1, wherein the time of the output of the second content item is based on a comparison of:
detected speech from one or more of the plurality of users; and
a transcript of the first content item.

6. The method of claim 1, wherein the time of the output of the second content item is based on body position and heart rate of one of the plurality of users.

7. The method of claim 1, further comprising storing information associating:
a plurality of secondary content items; and
a corresponding plurality of different attention thresholds that are to be met by the plurality of users before the corresponding secondary content item is to be outputted.

8. The method of claim 1, further comprising storing information indicating:
a plurality of secondary content items; and
for each of the secondary content items, relative importance values for:
a first type of feedback; and
a second type of feedback.

9. A method comprising:
determining feedback of a plurality of users who are looking in a direction of a computing device that is outputting a first content item; and
causing output of a second content item that is selected based on the feedback of the plurality of users during the outputting of the first content item.

10. The method of claim 9, wherein the selected second content item is based on eye gaze of each of the plurality of users.

11. The method of claim 10, wherein the selected second content item is based on eye gaze and audio captured proximate to the plurality of users.

12. The method of claim 9, wherein the selected second content item is based on a facial expression of one of the plurality of users.

13. The method of claim 9, wherein the selected second content item is based on a comparison of:
detected speech from one or more of the plurality of users; and
a transcript of the first content item.

14. The method of claim 13, wherein the selected second content item is based on body position and heart rate of one of the plurality of users.

15. The method of claim 9, further comprising storing information associating:
a plurality of secondary content items; and
a corresponding plurality of different attention thresholds that are to be met by the plurality of users before the corresponding secondary content item is to be outputted.

16. The method of claim 9, wherein the selected second content item is based on proximity of the plurality of users to a location of the first content item.

17. A method comprising:
determining feedback, from one or more sensors, of a user who is looking in a direction of a computing device that is outputting a first content item; and
causing output of a second content item that is selected based on body position and heartrate of the user during the outputting of the first content item.

18. The method of claim 17, wherein the selected second content item is based on an elevated heartrate of the user and the user facing towards the first content item.

19. The method of claim 17, wherein the selected second content item is based on a resting heartrate of the user and the user facing towards the first content item.

20. The method of claim 17, wherein the selected second content item is based on the user facing away from the first content item.
